(19) United States
(12) Patent Application Publication
(10) Pub. No.: US 2003/0128843 A1
(43) Pub. Date: Jul. 10, 2003

(54) Method and apparatus for preserving a strong random number across battery replacement in a security subsystem

(76) Inventors: Andrew Brown, Houston, TX (US); E. David Neufeld, Magnolia, TX (US)

Correspondence Address: Michael G. Fletcher, Fletcher, Yoder & Van Someren, P.O. Box 692289, Houston, TX, 77269-2289, US

(21) Appl. No.: 10/037,511

(22) Filed: Jan. 4, 2002

(51) Int. Cl. H04L 9/00

(52) U.S. Cl. 380/46

(57) ABSTRACT

A technique is provided for preserving a strong random number for use in a cryptographic security system for a processor-based device. The technique is particularly useful for restoring a random number to memory after data in the memory has been lost due to, for example, battery failure and replacement. Bits comprising a random number are automatically and periodically written to remote storage for subsequent recall, as needed, for substantially restoring the random number to the processor-based device. Further randomness also may be provided by masking in additional bits, such as those relating to other system components, the real-time clock, or the MAC address.

### BACKGROUND OF THE INVENTION

1. Field of the Invention

The present invention relates generally to a security system for an electronic or computing device and, more particularly, to a technique for preserving a strong random number across battery replacement in a security subsystem, such as a server or management subsystem.

2. Background Of The Related Art

This section is intended to introduce the reader to various aspects of art which may be related to various aspects of the present invention which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Computer security is becoming increasingly important in today's environment of heavily networked computer systems. As a result, security and integrity features are becoming desirable in the use of personal computers and servers. Providing “security” for a system involves protecting the system from a variety of possible attacks. Such security provisions may include protecting a system from accesses by hackers or other unauthorized entities. For example, for a specific business with proprietary internal systems and data, security provisions may involve prevention of rogue or external devices from accessing the internal machines. Prevention of access by unauthorized external devices may be particularly problematic if the internal system is configured for remote access via a publicly accessible network, such as the Internet.

One approach to security is the use of cryptography. Cryptography generally involves encryption of communications to prevent unauthorized access or reading of the communications. Encryption typically is accomplished through the use of a cryptographic algorithm, which is essentially a mathematical function. Most prevalent cryptographic algorithms are key-based algorithms, in which special knowledge of variable information called a “key” is required to encrypt and decrypt messages.

Two common types of key-based algorithms are a single key (or symmetric) algorithm and a “public key/private key” (or asymmetric) algorithm. A symmetric cryptographic algorithm is based on a secret, but shared, key which is used to both encrypt and decrypt messages. An asymmetric algorithm, in contrast, uses two related complementary keys: a publicly revealed key and a private (i.e., secret) key, each of which unlocks the code that the other key makes. In typical operation, the “public key” may be publicly available, such as via a readily accessible directory or the public portion of a digital certificate, while the corresponding “private key” is known only to the key pair owner. In an exemplary public key transaction, one party first attains the key pair owner's public key and uses it to encrypt a message prior to sending it. The key pair owner then decrypts the message with the corresponding private key.

Symmetric cryptographic systems are not always practical and may be subject to attack since the sender and recipient of a message must somehow exchange information regarding the shared key. However, a symmetric system does provide for relatively quick encryption and decryption of messages. On the other hand, asymmetric key systems typically offer better security but they are relatively slower.

Because public/private key encryption algorithms are slow relative to shared key systems, secure communications in many computing systems often are implemented using a hybrid approach in which a session between two parties may be initiated using a public key/private key system and then continued using a shared key. For example, to initiate the session, one party may retrieve the other party's public key and use it to encrypt a shared key. The other party retrieves the shared key by decrypting it using the private key that corresponds to the public key. Further messages between the parties then may be encrypted/decrypted using the shared key and a symmetric algorithm. Accordingly, the problem with exchanging a shared secret key in a non-secure environment is circumvented, while the significantly increased speed available from the symmetric key system is provided.

To generate keys (either symmetric or Public/Private), the cryptographic algorithm uses a random number such that each key that is generated is unique and unpredictable. Typically, the random number is obtained by performing a mathematical operation on data stored in a “seed pool,” which essentially is a collection of randomly generated bits. The more random the manner in which the seed pool is generated and the larger the number of bits used, the greater the unpredictability of the generated keys, thus strengthening the security of the system.

In many instances, the seed pool is initialized and stored in nonvolatile memory (e.g., ROM, EEPROM, flash memory, or, typically, NVRAM) of the system, while the system is in a “non-hostile” (i.e., limited security risk) environment. For example, the seed pool may be generated by a conventional random number generator and injected into nonvolatile memory during the manufacturing process or while being serviced by authorized personnel. In the manufacturing environment, injection of the seed pool may be part of the system initialization process or a step (or station) in the manufacturing process. In a service environment, injection of a seed pool may be allowed only if a large number of highly unpredictable bits can be obtained.

Once the seed pool is placed into memory, the cryptographic algorithm may use the seed pool to generate keys. In many systems, the nonvolatile memory in which the seed pool is stored is backed-up by a replaceable, limited life power source, such as a lithium battery. It is not unusual that such power sources may require replacement every four to five years. Unfortunately, if the nonvolatile memory loses all power sources, then the data stored in the nonvolatile memory is lost. For example, if the primary power source for the nonvolatile memory is lost or removed (e.g., unplugged) while the backup power source (e.g., the limited life battery) is in a weakened or dead state (e.g., low or no voltage), then the seed pool is lost from the nonvolatile memory and the cryptographic security system is disabled.

Accordingly, a technique is needed for preserving the seed pool during a power loss event, which purges the seed pool from the memory storing the seed pool. A technique is also needed for ensuring randomness of the seed pool to maintain its effectiveness for the cryptographic security system. If the

### DESCRIPTION OF THE DRAWINGS

The foregoing and other advantages of the invention will become apparent upon reading the following detailed description and upon reference to the drawings in which:

FIG. 1 illustrates a block diagram of an exemplary processor-based device having seed pool generation and backup systems;

FIG. 2 illustrates a block diagram representing an exemplary embodiment of a server which implements the seed pool generation and backup systems in accordance with the invention;

FIG. 3 illustrates a block diagram representing an exemplary embodiment of the random number generation system within the device or server of FIGS. 1 and 2;

FIG. 4 illustrates a flow chart of an exemplary technique for initiating a communication session between the device or server of FIGS. 1 and 2 and an external device;

FIG. 5A illustrates a flow chart of an exemplary technique for determining the need for a new or backup seed pool while operating the device or server desiring the seed pool for security;

FIG. 5B illustrates a flow chart of an exemplary technique for generating the seed pool after determining the need for a new seed pool according to FIG. 5A;

FIG. 6 is a flow chart illustrating an exemplary process for generating, backing-up, and restoring a random seed pool to a security system;

FIG. 7 is a diagram illustrating the security system in the process of backing-up the random seed pool;

FIG. 8 is a diagram illustrating the security system in the process of receiving a new battery and being repopulated with the backup seed pool;

FIG. 9 is a diagram illustrating the security subsystem in the process of modifying the restored backup seed pool with additional random bits; and

FIG. 10 is a diagram illustrating the security system with a random seed pool based on the foregoing seed pool restoration and modification techniques.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions are made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As described in detail below, the present technique provides a variety of systems and methods for generating and preserving a seed pool, which can be employed in a variety of processor-based devices that benefit from the use of random numbers. For example, random numbers may be particularly useful in conjunction with a cryptographic security system, which is employable for verifying the identity and/or authority of an entity attempting to access the processor-based device, and also for encrypting/decrypting messages between the processor-based device and an external device. These messages may be exchanged over any of a variety of types of communication links, such as a wired connection, wireless connection, network, intranet, Internet, etc. In applications such as cryptographic security systems, the availability of the random seed pool is critical. Accordingly, the present technique specifically addresses power loss events, which purge the seed pool from the memory storing the seed pool. For example, if the seed pool is lost while the primary power source is lost or removed and the backup power source (e.g., the limited life battery) is in a weakened or dead state (e.g., low or no voltage), then the present technique may generate a new random seed pool or repopulate the memory with a backup seed pool. Moreover, the present technique may add random bits to the seed pool to ensure randomness of the seed pool for use by the cryptographic security system.

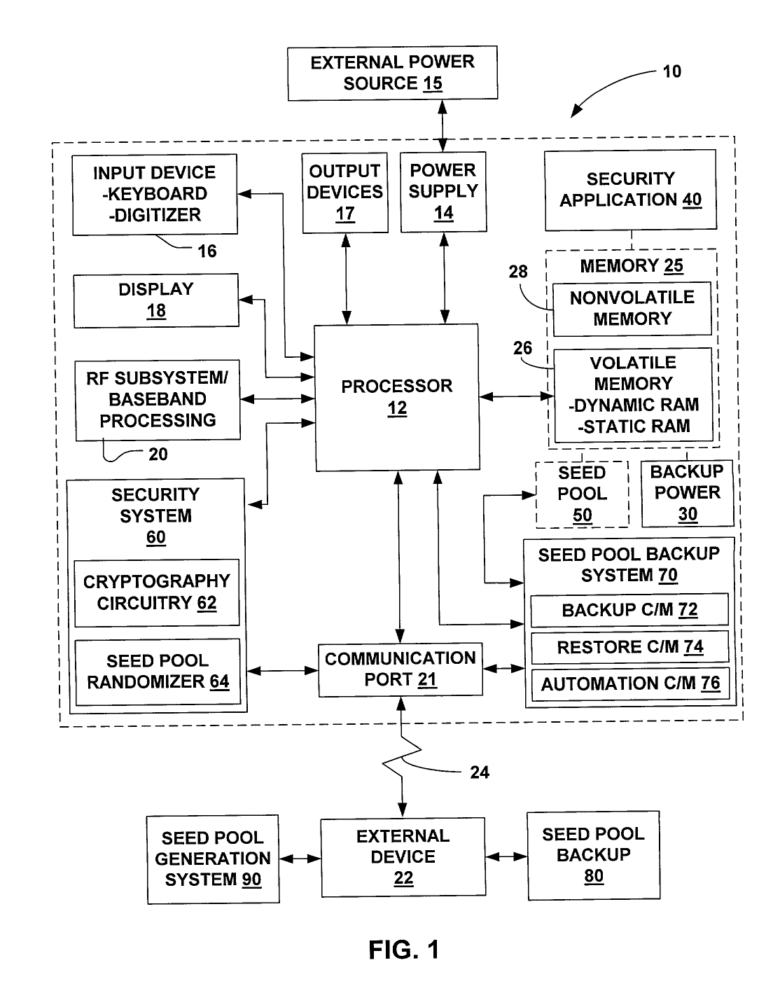

FIG. 1 is a block diagram illustrating an exemplary processor-based device 10 of the present technique. The processor-based device 10 may embody a desktop computer, a portable computer, a server, an Internet appliance, a pager, a cellular telephone, a personal digital assistant, a control circuit, or any other desired device. In a typical processor-based device, a processor 12, such as a microprocessor, controls many functions of the device 10.

The illustrated device 10 comprises a main power supply 14, which may comprise a variety of mobile and stationary power circuitry and supplies 15, depending on the particular application and components of the device 10. For example, if the device 10 is portable, then the power supply 14 may include permanent batteries, replaceable batteries, and/or rechargeable batteries. The power supply 14 also may include a variety of power adapters, such as an A/C adapter for plugging the device 10 into a wall outlet and a D/C adapter for plugging the device 10 into an automobile's cigarette lighter power socket.

Various other devices may be coupled to the processor 12 depending upon the particular functions of the device 10. For example, a user interface device 16 may be in communication with the processor 12 through appropriate user interface software. The user interface device 16 may include buttons, switches, a keyboard, a light pin, a mouse, and/or a voice recognition system. The device 10 also may include a variety of output devices 17, such as a printer, a scanner, or speakers, which communicate with the processor 12 through an appropriate communications port. The processor 12 also may support a display 18, such as an LCD display or a CRT monitor. Furthermore, an RF subsystem/baseband processor 20 may be coupled to the processor 12. The RF subsystem/baseband processor 20 may include an antenna that is coupled to an RF receiver and to an RF transmitter (not shown). A communications port 22 also may be coupled to the processor 12. The communications port 21 is adapted to for coupling to an external device 22 via a communications link 24, which may embody a local area network (LAN), a wide area network (WAN), the Internet, or any other local or remote communications system. The external device 22 may embody a peripheral device, a desktop computer system, a portable computer system, a server, or any other suitable electronic or networked device.

The device 10 also has memory 25 coupled to the processor 12 to store data and facilitate execution of a software program, which facilitates control of the device 10 under the computing power of the processor 12. As illustrated, the memory 25 includes volatile memory 26 and nonvolatile memory 28. The volatile memory 26 may comprise dynamic random access memory (DRAM), static random access memory (SRAM), and a variety of other volatile memory modules. The nonvolatile memory 28 may comprise read only memory (ROM), such as an EPROM and/or Flash memory, for use in conjunction with the volatile memory 26. The size of the ROM is typically selected to be just large enough to store any necessary BIOS operating system, application programs, and fixed data. The volatile memory 26, on the other hand, is typically quite large so that it can store dynamically loaded applications. Additionally, the nonvolatile memory 28 may include a high capacity memory such as a disk or tape drive memory.

The memory 25 also may have one or more backup power sources, such as backup power 30, to ensure that the portions of the memory 25 requiring continuous power do not lose power in the event of a main power loss. For example, the backup power 30 may embody a small battery, such as a lithium battery, which has a relatively limited life (e.g., four to five years). If the primary power source 14 is lost or removed, then the backup power 30 operates to ensure continuous power to memory 25. However, the useful life of the backup power supply 30 may depend on the voltage needed by the memory 25. For example, if the voltage output by the backup power supply 30 falls below a critical voltage level needed by the memory 25, then the backup power supply 30 may not effectively protect the memory 25 from memory loss during a primary power loss.

Unfortunately, a total power loss by both the primary power supply 14 and the backup power supply 30 may cause data loss of critical system files and parameters, such as a security application 40 and a seed pool 50. Although the security application 40 may be stored on a hard disk drive, the seed pool 50 may be stored on a power-dependent portion of the memory 25. If the seed pool 50 is purged from the memory 25 during a total power loss, then the security application 40 and security system 60 is unable to provide security for the device 10. In this exemplary embodiment, security system 60 comprises cryptography circuitry 62 and a seed pool randomizer 64. In operation, the device 10 may use the security application 40, the seed pool 50, and the cryptography circuitry 62 to provide data encryption for communications between the device 10 and the external device 22 via the communications link 24. The device 10 also may use the seed pool randomizer 64 to modify the seed pool 50, such as by adding random bits, to ensure randomness of the seed pool 50. If the seed pool 50 is lost during a total power loss event, then the security system 60 is disabled and communications with the device 10 are vulnerable.

Accordingly, the device 10 comprises a seed pool backup system 70, which transmits a copy of the seed pool 50 to the external device 22 for storage of a seed pool backup 80. The seed pool backup system 70 routinely, or periodically, backs-up the seed pool 50 for retrieval by the device 10 in the event of a total power and memory loss by the device 10. The seed pool backup system 70 may comprise a variety of hardware and software modules for backing up in restoring the seed pool 50, such as a backup control module 72, a restoration control module 74, and an automation control module 76. The backup control module 72 is configured for periodically storing a backup of the seed pool in the external device 70, while the restoration control module 74 is configured for repopulating the power dependent memory portion of the memory 25 with the seed pool backup 80 following a total power and seed pool loss from the memory 25. For example, the device 10 may automatically retrieve the seed pool backup 80 following battery replacement and/or power restoration to the device 10 by operation of the automation control module 76. The device 10 may then use the seed pool randomizer 64 to modify the restored seed pool backup 80. Accordingly, the seed pool backup system 70 minimizes the downtime for the security system 60. Alternatively, a new seed pool can be generated for the device 10. For example, the external device 22 may comprise a seed pool generation system 90 that may be used to create a new seed pool for the device 10 following a total power and memory loss by the device 10. In an exemplary embodiment, the seed pool generation system 90 automatically generates a new seed pool for the device 10 following battery replacement and/or power restoration to device 10. The foregoing seed pool backup and generation systems 70 and 90 are discussed in detail below.

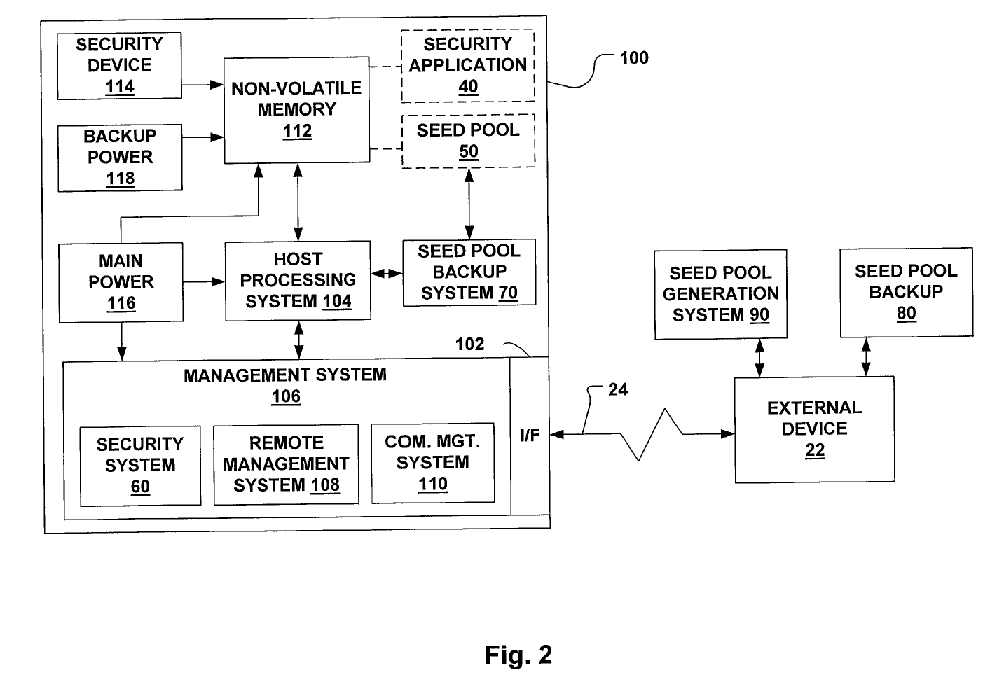

As discussed above, the device 10 can be any of a variety of types of processor-based devices. In the exemplary embodiment described below with respect to FIGS. 2-5, the processor-based device 10 is a device 100 (e.g., a server) that has a communication port or interface 102 adapted for communication, locally and/or remotely, with an external device 22 (i.e., another processor-based device) via a communication link 24. The communication link 24 may comprise a wired link and/or wireless link, and either may be a local link between the external device 22 and the server 100 or part of a network, such as a local area network, intranet, and/or Internet.

FIG. 2 illustrates a block diagram representing some of the functional blocks of the server 100. The server 100 includes a host processing system 104, which implements the features of the processor-based device 10 shown in FIG. 1. For example, the host processing system 104 may include one or more microprocessors, such as a Merced® or Pentium® processor available from Intel Corporation, as well as any number of similar suitable processors available from other manufacturers. The host processing system 104 also includes a variety of buses, such as a host bus, an Industry Standard Architecture (ISA) bus, an Extended Industry Standard Architecture (EISA) bus, a Peripheral Component Interface (PCI) bus, or a Universal Serial Bus (USB). The server 100 also includes a memory system, which is coupled to the buses in an appropriate configuration. The memory system may include devices such as a memory controller, cache memory, data buffers, random access memory (RAM), read only memory (ROM), a hard drive, a removable media drive (e.g., a floppy disk drive, a CD/DVD drive, etc.), a video controller, video memory, etc.

The host processing system 104 also may include or communicate with miscellaneous system logic, such as counters, timers, interrupt controllers, power management logic, and a management system 106. The host processing system 104 also may have a communications interface device 102, such as a network interface controller (NIC) or an RS232 interface controller, for communicating with the external device 22 via the communications link 24. In this exemplary embodiment, the management system 106 comprises the security system 60, a remote management system 108, and a communications management system 110. The security system 60 includes the cryptography circuitry 62 and the seed pool randomizer 64, as illustrated in FIG. 1. The communications management system 110 comprises a variety of hardware and software applications for communicating with peripheral devices and other computer systems, such as the external device 22, via the communications link 24.

The remote management system 108 may comprise a variety of circuitry and software for remotely managing network devices and the server 100 via the external device 22. For example, the remote management system 108 may comprise a “lights out” management system, which is particularly well suited for use in a headless server lacking user interaction devices, such as a monitor, a keyboard, and a mouse. For example, the LOM board may be a Remote Insight Lights-Out Edition board from Compaq Computer Corp., Houston, Tex. The LOM board provides Web browser access to the server 100 through a seamless, hardware-based, OS-independent graphical remote console. The LOM board provides full control of hardware and operating systems of the server 100 through the Web browser no matter where the server 100 is located.

In the exemplary embodiment illustrated in FIG. 2, the remote management system 108 may include its own microprocessor to perform processing functions related to communicating with the external device 22 via the interface 102 and the communication link 24. For example, the remote management system 108 may provide access to the host processing system 104 by the external device 22 in nonfunctional states of the host processing system 104 or the security system 60. Accordingly, the remote management system 108 may facilitate maintenance operations, servicing, and other control/management operations for the server 100 via the external device 22. For example, the server 100 may retrieve data relating to server operations (e.g., server security) from the external device 22, which may then interact with the server 100 to ensure proper operation of the server 100. Additionally, the external communication capability may provide access to, and interaction with, the processing capabilities of the server 100 and other features of the host processing system 104, such as the input/output buses (e.g., PCI or USB buses). In any event, as discussed above, any provision of a feature which permits an external device to connect to and access the server 100 presents a security risk. Accordingly, the security system 60 comprises a variety of hardware and software security systems, such as the cryptography circuitry 62 and seed pool randomizer 64, to restrict and govern external access to the server 100 and to encrypt communications with the server 100.

The host processing system 104 and the management system 106 both have access to data stored in a nonvolatile memory 112, which, in an exemplary embodiment, is included in the management system 106. The memory 112 may include a variety of memory, such as ROM, EPROM, flash memory, nonvolatile RAM (NVRAM), and any other desired memory modules. The memory 112 may store a variety of configuration parameters and files, software applications, operating systems, and various data critical to operation of the server 100 and specific subsystems. For example, the memory 112 may store a BIOS and security management data, such as the security application 40 and the seed pool 50, which is needed for effective security for the server 100. In certain applications, it may be desirable to limit access to portions of the memory 112, such as memory storing the seed pool 50, to prevent unauthorized access or corruption of sensitive data. In the exemplary embodiment, the server 100 is configured to limit access to the memory 112 storing the seed pool to only the management system 106, and specifically, the security system 60.

A security device 114 also may be provided for controlling or restricting write accesses to the memory 112 or portions of the memory 112. In the exemplary embodiment, the security device 114 comprises a jumper wire which is installed in an appropriate location within the chassis of the server 100 during system initialization or a service event. If the security device 114 is not properly installed, then write accesses to protected memory portions may be denied.

Moreover, the security device 114 should be removed from the server 100 upon completion of the initialization procedure or the service event to prevent unauthorized access to the restricted portions of the memory 112.

The host processing system 104 and the communications management system 110 both derive power from a main power source 116. The main power source 116 may be a power supply connected to a conventional AC power source. Alternatively, the main power source 116 may include a battery. As discussed above, the main power source 116 may be lost or removed in a variety of situations, such as circuitry failure in the main power source 116, disconnection of the main power source 116 from a power outlet, a power surge, or any other potential power loss event.

Accordingly, the server 100 also includes a backup power source 118, which is provided to prevent loss or corruption of data stored in the memory 112 during a main power loss event. For example, if the main power source 116 fails, then the backup power source 118 ensures that the memory 112 has sufficient power to operate and retain the stored data, such as the seed pool 50. In the exemplary embodiment, the backup power source 118 comprises a lithium battery, which typically has a life of approximately four to five years. As discussed above, data related to the server's security system may be stored in the memory 112. In certain applications, the stored data may be necessary for authorizing an external device 22 to access the server 100, while other applications require the seed pool 50 for data encryption of communications between the server 100 and the external device 22. Thus, if the backup power source 118 fails, weakens below a critical voltage level, or generally fails to power the memory 112 during a main power loss, then the security of further external accesses to the server 100 is compromised until the seed pool 50 is rewritten to the protected portion of the memory 112.

The present technique addresses the problem of restoring the seed pool 50 to the memory 112 for use by the security system 60 in generating keys for the cryptographic security algorithm. It should be understood that the technique described herein is applicable to any situation in which a random seed pool is needed for securing the server 100 or for securing communications between the server 100 and the external device 22. For example, the present technique is applicable to an initialization process, a data corruption event, or a data loss event associated with the seed pool 50.

The seed pool 50 may be initially written, or subsequently restored, to the memory 112 by a service technician who is physically present at the location of the server 100. In the embodiment illustrated in FIG. 2, the service technician must open the chassis of the server 100, install the security device 114, and restore the security data to the memory 112 using an appropriate random number generator. However, such a solution to re-establishing a secure, external communications capability may not be optimal, because it requires the physical presence of a properly trained technician, physical access to the server 100, and confidence that the technician will remove the security device 118 upon completion of the task. Accordingly, it would be advantageous to provide the seed pool backup system 70 or remote access to the seed pool generation system 90.

Accordingly, as illustrated in FIG. 2, the server 100 comprises the seed pool backup system 70 for routinely, or periodically, transmitting a copy of the seed pool 50 to the external device 22 for storage as a seed pool backup 80. If the seed pool backup system 70 subsequently detects that the seed pool 50 has been lost from the memory 112, then the seed pool backup system 70 may retrieve the seed pool backup 80 automatically from storage at the external device 22. For example, the seed pool backup system 70 may check the memory 112 for the seed pool 50 every time the server 100 is re-powered following a total power shutdown. Alternatively, the present technique provides the seed pool generation system 90, which may be used to create a new seed pool for the server 100. Again, if the seed pool 50 is lost, then the server 100 may automatically transmit a seed pool request to the external device 22, which then operates the seed pool generation system 90 to create a new seed pool for the server 100. The external device 22 then transmits the new seed pool to the server 100 to enable the security system 60. A user also may interact with the server 100 via the remote management system 108, which allows the user to repopulate the memory 112 with a new seed pool generated by the seed pool generation system 90 or with the seed pool backup 80 stored by the seed pool backup system 70. In either case, the seed pool backup system 70 or the seed pool generation system 90 may operate automatically upon re-powering the server 100 following a total power and memory loss of the seed pool 50.

It also would be advantageous to provide one or more triggering events, which initiate one of the systems 70 and 90. For example, exemplary triggering events for the systems 70 and 90 may include a power loss or shutdown of the server 100 and a detected memory loss of the seed pool 50 from the memory 112. In an exemplary embodiment of the present technique, the 5 security system 60 may check the memory 112 for the seed pool 50 in any of the following circumstances: (1) upon re-powering the server 100 after a power loss or shutdown of the server 100, (2) on a routine basis by the seed pool backup system 70 (e.g., as the system 70 attempts to backup the seed pool 50), (3) upon request by the security system 60 (e.g., as the cryptography circuitry 62 attempts to create cryptographic keys), (4) or any other suitable routine or triggering event. If the seed pool 50 is not resident in the memory 112, then the server 100 may initiate one of the systems 70 and 90 to repopulate the memory 112 with a new or backup seed pool. To heighten the security of a cryptographic system, it is important that the cryptographic keys be unique and highly unpredictable. Accordingly, the server 100 also may operate the seed pool randomizer 64 after repopulating the memory 112 with the new or backup seed pool.

As previously discussed, generation of a cryptographic key is based on a number (i.e., a collection of digital bits referred to as a “seed pool”) that is randomly generated. The more unpredictable or random the manner in which the bits are collected, the more secure the system will be. Thus, for a strong random number, even though the particular technique or algorithm for generating the collection of bits which combine to form the random number may be known, the actual value of the resultant random number should be unpredictable.

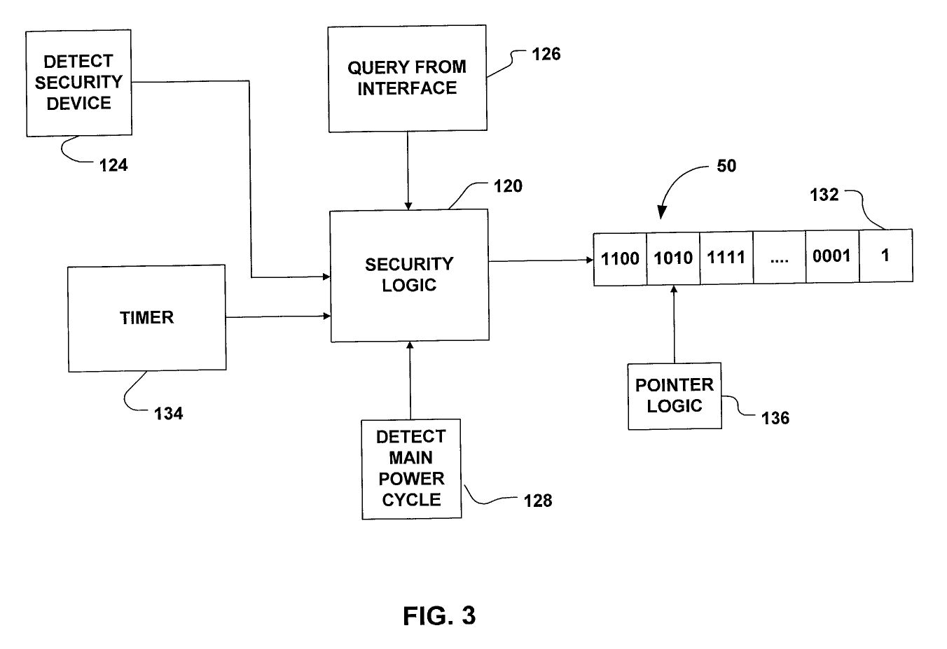

FIG. 3 is a block diagram of an exemplary embodiment of the seed pool generation system 90, which may operate to initialize or restore the population of the seed pool 50. As mentioned above, the seed pool generation system 90 may be implemented in any suitable manner in software, hardware, and/or firmware to generate a collection of random bits, such as a collection of 128 bytes (i.e., 1024 bits) of data. Accordingly, the seed pool generation system 90 operates to generate a new seed pool, if needed, by adding one or more bits to the new seed pool in discrete increments, each increment corresponding to a triggering event having an unpredictable and variable duration or latency. For example, each time the triggering event occurs, one or more bits are added to the seed pool upon termination of the triggering event if the seed pool is not already populated.

As illustrated, security logic 120 receives or detects input information from several sources. For example, the logic 120 of FIG. 2 is configured to detect a variety of triggering events that result in data being added to the new seed pool 50: (1) the presence of a security device 114 that allows write accesses to the memory 112 (block 124); (2) a query received via the interface 102 as a result of an access request from an external device 22 (block 126); (3) cycling of the main power source 116 (block 128); or (4) any other random triggering events. Once the new seed pool 50 is full, then the seed pool generation system 90 may stop adding bits to the new seed pool 50.

In any of the foregoing triggering events, as the seed pool 50 is being incrementally filled, the seed pool generation system 90 may evaluate the populated state of the seed pool 50. For example, the logic 120 may examine the position of a pointer to determine whether the portion of the memory 112 for storing the seed pool 50 is full. Alternatively, the logic 120 may be configured to examine the state of a bit 132 in the memory 112 that is representative of the populated state of the seed pool 50. For example, the bit 132 may be set when the seed pool 50 is fully populated. If the backup power source 118 fails (e.g., insufficient or no voltage, removed, etc.) during a primary power shutdown of the main power 116, then the bit 132 may be reset to indicate an empty or lost seed pool 50. The population of the seed pool 50 also may be indicated by a counter (not shown), which counts each triggering event that causes bits to be added to the seed pool 50. Alternatively, the security logic 120 may count the number of times bits are captured from the timer 134 and are written to the seed pool 50. After the seed pool 50 has been fully populated by the foregoing triggering events, then the security logic 120 may change the state of the bit 132 to indicate a fully populated seed pool 50.

If the security logic 120 detects any of the foregoing triggering events, then the logic 120 evaluates the seed pool 50 to determine if the seed pool 50 has been fully populated. If the logic 120 determines that the seed pool 50 is not adequately populated, then the logic 120 reads the bits of a free-running timer 134 (e.g., the four least significant bits) and writes those bits to the seed pool 50. For example, the logic 120 may write the bits to the location in the memory 112 indicated by a seed pool pointer logic 136. The pointer logic 136 then may increment to the next location in the memory 112 for the seed pool 50.

As mentioned above, the unpredictability of the triggering event ensures that the seed pool is random and unpredictable. Several variable factors contribute to the unpredictability of the timing of the event (i.e., the delay or latency introduced by the event). The time lapse between the initiation and termination of the triggering event is unpredictable and variable, thus increasing the probability that the value of the one or more bits captured from the timer and placed in the seed pool also is unpredictable. For example, the hardware clocking in the controller in the interface 102 is typically asynchronous to processing functions performed in the communication management system 110, thus providing a degree of uncertainty introduced by synchronization logic. Further, the delay in transmitting communications between the device 22 and the interface 102 is dependent on the bandwidth of the communication link 22 (which can vary depending on the particular system and link used) as well as the amount of other traffic contending for that bandwidth (which can vary in real time). Other factors contributing to the unpredictability of the latency of the triggering event may include the number of communication packets in cache memory on either side of the communication link 22, the size of the TCP/IP stack on either side of the link 22, the length of the resultant TCP/IP communication packet transmitted on the link 22, and the manner in which error checking is performed on the packets. Moreover, other variable delays may exist in the process of determining whether the seed pool 50 is adequately populated.

The seed pool generation system 90 also may use a variety of other triggering events having an unpredictable and variable latency. Alternatively, the system 90 may use multiple triggering events, such as those described above, to provide an even greater degree of randomness. For example, a second type of triggering event may be used in conjunction with a first type of triggering event, such that both events contribute to the population of the seed pool. Again, as described above, the multiple triggering events add bits to the seed pool only if the seed pool 50 is not already fully populated.

As mentioned above, the seed pool randomizer 64 also may be used to ensure continuous randomness of the seed pool 50, thereby providing increased unpredictability of the seed pool 50 and effectiveness of the security system 60. For example, the present technique may use any of the foregoing triggering events to operate the seed pool randomizer 64, which masks the least significant bit of the timer 134 into the seed pool 50 at the location indicated by pointer logic 136, even if the seed pool 50 is already fully populated. The pointer logic 136 may then increment to a next location of the seed pool 50 in the memory 112. Occasionally masking bits into the seed pool 50 contributes a further degree of unpredictability (or entropy) in the generation of the random number for the cryptographic security system.

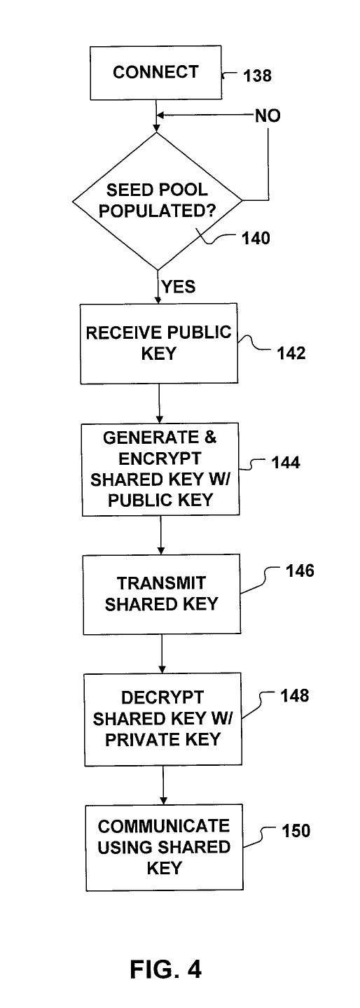

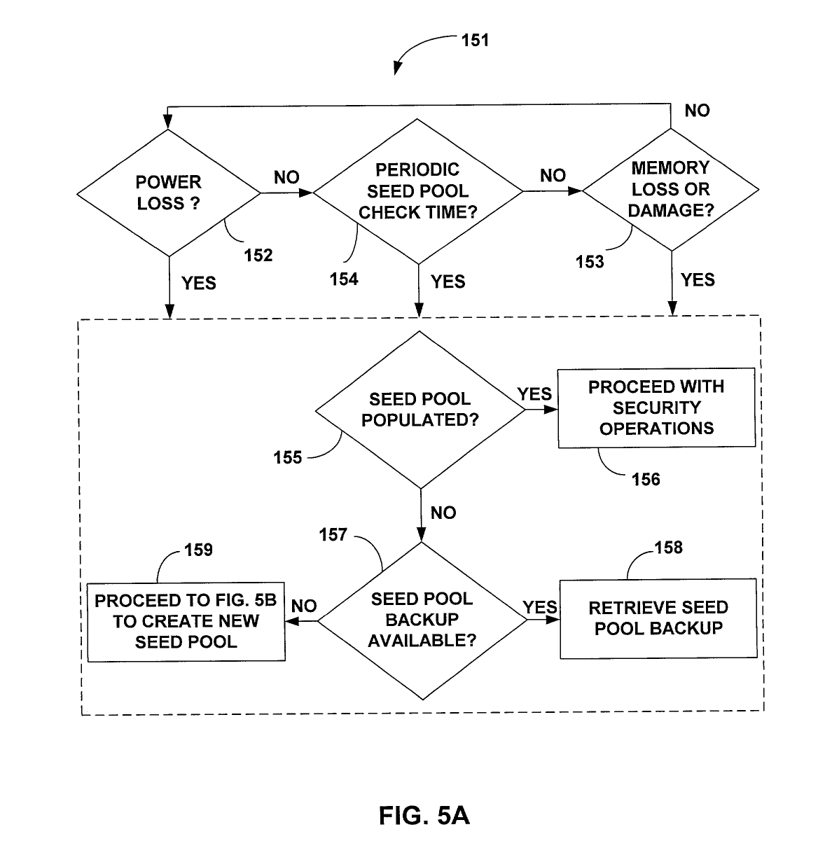

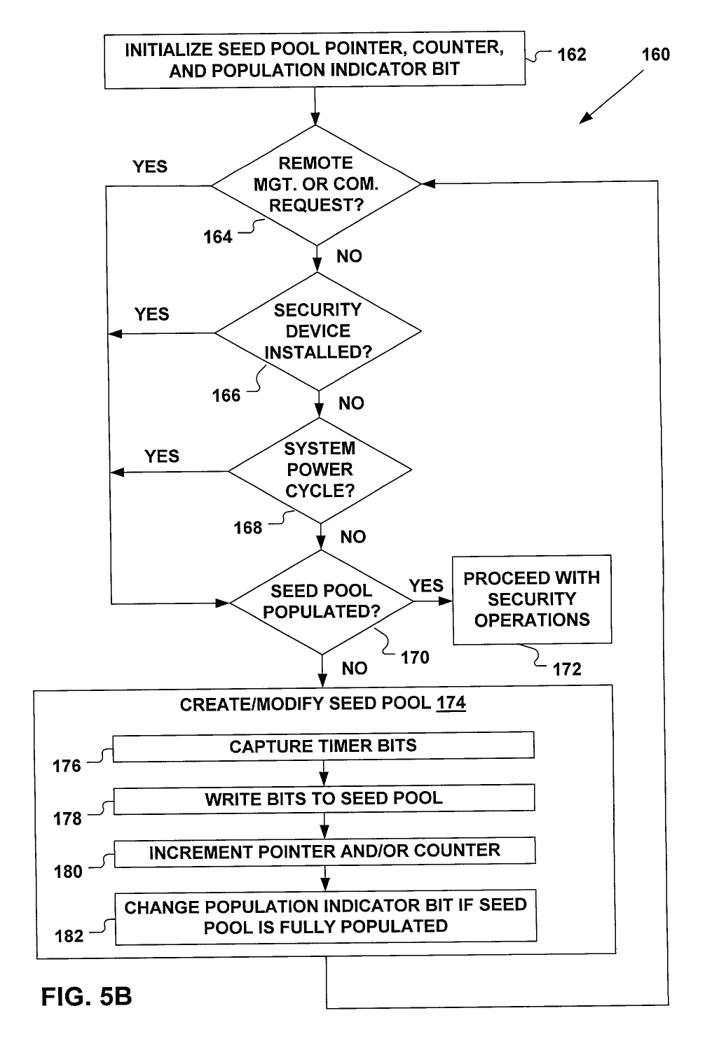

The security management technique described above and implemented by the server 100 is further illustrated by the flowcharts of FIGS. 4, 5A and 5B. FIG. 4 illustrates an exemplary initiation of a communication session between the server 100 and the external device 22. FIG. 5B illustrates an exemplary seed pool valuation technique for identifying the need for a new or backup seed pool. FIG. 5 illustrates an exemplary technique for generating a new seed pool 50, such as by operating the seed pool generation system 90 illustrated by FIG. 3. If

Turning first to FIG. 4, in block 138, the external device 22 establishes a connection to the server 100 via the communication link 24 and the communication interface 102. In an embodiment in which the interface 102 includes a network interface controller, the communication link 24 may include the Internet. When the external device 22 attempts to connect to the server 100, the external device 22 may transmit information, such as a digital certificate, which authenticates the device's 22 identity and its authorization to access the server 100. In the exemplary embodiment, the external device 22 also queries the server 100 to determine whether the seed pool 50 stored in the memory 112 of the server 100 is populated (block 140). If the seed pool 50 is not present or adequately populated, then the communications management system 22 cannot obtain a random number for generating the public/private key pair for the cryptographic security system. If the keys cannot be generated, then communications between the server 100 and the device 22 cannot proceed. Accordingly, the device 22 repeats the query until an affirmative response is received or until the query times out, indicating an operational error.

If the server 100 does have an adequate seed pool, and provided the server 100 has verified that the external device 22 has the appropriate authorization, the server 100 transmits information to the device 22 that allows it to log on and initiate a session. For example, the server 100 may transmit a digital certificate which authenticates the server's identity along with a Java applet which allows the device 22 to log on to the server 100 and function as a Web browser (e.g., a Secure Socket Layer (SSL)-enabled browser). The information transmitted from the server 100 to the device 22 also includes the public key for the cryptographic algorithm that allows the device 22 and the server 100 to exchange communications.

Upon receipt of the public key (block 142), the external device 22 generates a session key and encrypts it using the server's public key (block 144). The device 22 may include, for example, a random number generator that provides a random number used to generate the session key. The encrypted session key then is transmitted to the server 100 (block 146), which decrypts it using the corresponding private key (block 148). Because both the server 100 and the device 22 now have knowledge of the shared, secret session key, communications between the server 100 and the device 22 may thereafter proceed using the session key and a symmetric cryptographic algorithm (block 150).

Turning now to FIGS. 5A and 5B, an exemplary technique for populating the seed pool 50 is illustrated with reference to FIG. 3. As illustrated, FIG. 5A is a flow chart illustrating an exemplary seed pool evaluation and population process 151, which determines whether a new or backup seed pool is needed by the device 10 or the server 100. If the process 151 determines that the seed pool 50 has been lost, then the process 151 repopulates the seed pool 50 using either the seed pool backup system and 70 or the seed pool generation system 90. FIG. 5B illustrates operation of the seed pool generation system 90, which uses a variety of triggering events to capture random timer bits incrementally until the seed pool 50 is fully populated.

As illustrated in FIG. 5A, the process 151 may evaluate a variety of factors to determine whether the seed pool requires repopulation by either the seed pool backup system 70 or the seed pool generation system 90. In this exemplary embodiment, the process 151 may evaluate whether the seed pool 50 is populated after a power loss 152 (e.g., after a main power shutdown), after a memory loss or damage to memory 153, or at a periodic seed pool check interval 154 (e.g., at a periodic seed pool backup interval). The process 151 continues to evaluate the foregoing triggers 152-154 to ensure minimal downtime of the security system 60 in the event of memory loss of the seed pool 50. Accordingly, if any of these triggers 152-154 occur, the process 151 proceeds to evaluate whether the seed pool 50 is populated (block 155). If the process 151 determines that the seed pool 50 is populated, then the device 10 or the server 100 may proceed with security operations, such as data encryption of electronic transmissions (block 156). However, if the process 151 determines that the seed pool 50 is not populated, then the process 151 queries whether a seed pool backup is available for the device 10 or server 100 (block 157). If the seed pool backup query 157 identifies an available seed pool backup, such as the seed pool backup 80, then the process 151 proceeds to retrieve the seed pool backup and to repopulate memory of the device 10 or the server 100 with the seed pool backup (block 158). However, if the seed pool backup query 157 does not identify an available seed pool backup, then the process 151 proceeds to FIG. 5B to create a new seed pool for the device 10 or the server 100 (block 159).

As mentioned above, FIG. 5B illustrates an exemplary seed pool generation process 160, which uses a variety of triggering events to capture random timer bits incrementally until the seed pool 50 is fully populated. The process 160 proceeds by initializing the seed pool generation system 90, including initializing the pointer logic 136, setting or resetting counters, and setting or resetting the state of the state bit 132 (block 162). The logic initialization step may occur as a part of the system initialization during the manufacturing process, or as a result of the seed pool evaluation process 151 illustrated in FIG. 5A.

After the process 160 initializes the seed pool generation system 90, the seed pool 50 can be populated with an appropriate number of randomly generated bits based on the occurrence of one or more triggering events, such as described above with reference to FIG. 3. In the exemplary embodiment, the triggering events include receipt of a query from an external device 22 that is attempting to access the server 100 (block 164), installation of the security device 124 and receipt of a write request to the seed pool 50 (block 166), and detection of a cycle of the main power source 116 (block 168).

If any of the foregoing triggering events 164-168 occurs, then seed pool generation process 160 proceeds to query whether the seed pool 50 has been fully populated by the process 160 (block 170). If the process 160 has already populated the seed pool 50 to the desired number of bits (e.g., 1024 bits), then the process 160 allows the device 10 or the server 100 to proceed with security operations (block 172). However, if the seed pool population query 170 determines that the seed pool 50 has not been filly populated by the process 160, then the seed pool generation process 160 proceeds to create or modify the seed pool 50 (block 174). Accordingly, the process 160 proceeds to capture one or more bits of a random bit generator, such as the timer 134 (block 176). The captured random bits are then written to the seed pool 50 (block 178). As discussed above, the location in the memory to which the one or more bits are written may be indicated by the pointer logic 136. The process 160 may then proceed to increment the pointer logic 136 to point to a next location in the memory for subsequent bits to be added to the seed pool (block 180). Moreover, if a counter is implemented by the device 10 or the system 100, then the process 160 may increment the counter based on the number of bits written to the pool 50 (block 180). Still further, if the seed pool 50 has been fully populated by the incremental write to memory at block 178, then the state of the bit 132 may be changed to indicate that the pool 50 is fully populated. If the seed pool 50 is not fully populated, then the seed pool generation process 160 returns to query 164 to detect the next triggering event.

As discussed above, the random seed pool 50 used by security systems to provide a random number for cryptography may be lost or corrupted due to a variety of reasons, such as battery failure. If the seed pool 50 is lost, then a new seed pool may be generated by the seed pool generation system 90 and process 160, as described above, or the backup seed pool 80 may be rewritten to the memory of the device 10 or the server 100. If the seed pool generation system 90 is inaccessible or inoperable, then it would be advantageous to have the seed pool backup 80 available for immediate recovery of the security system 60. Moreover, the seed pool backup 80 may decrease downtime of the security system 60 relative to the seed pool generation system 90, which generally requires a plurality of triggering events to create the seed pool 50.

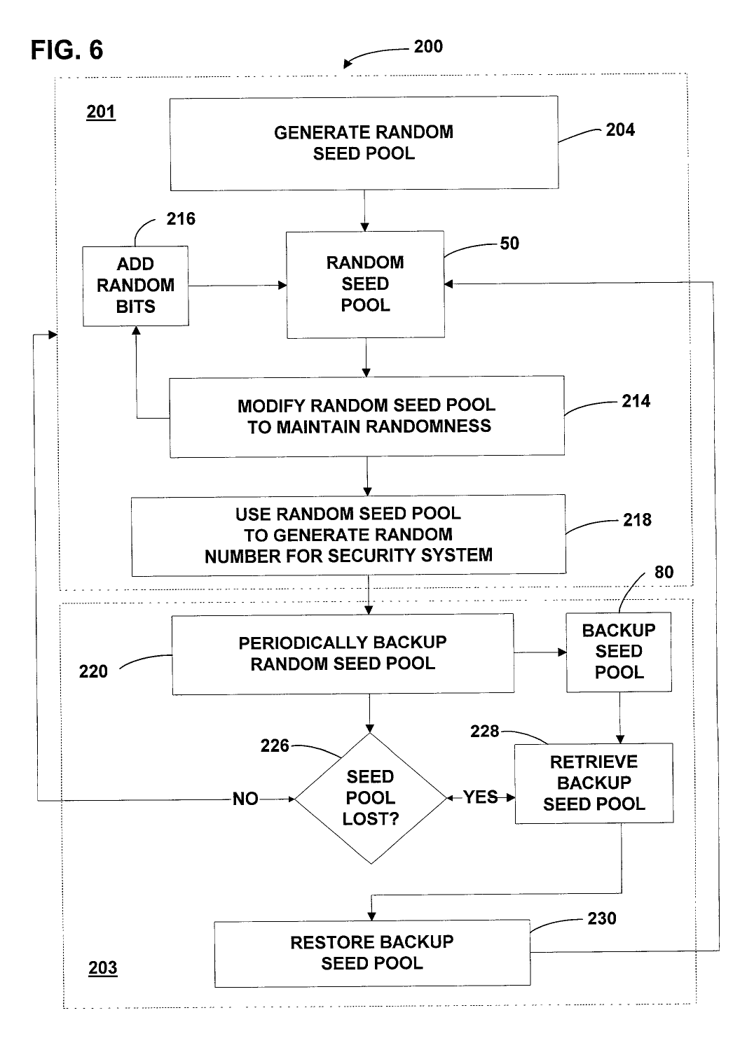

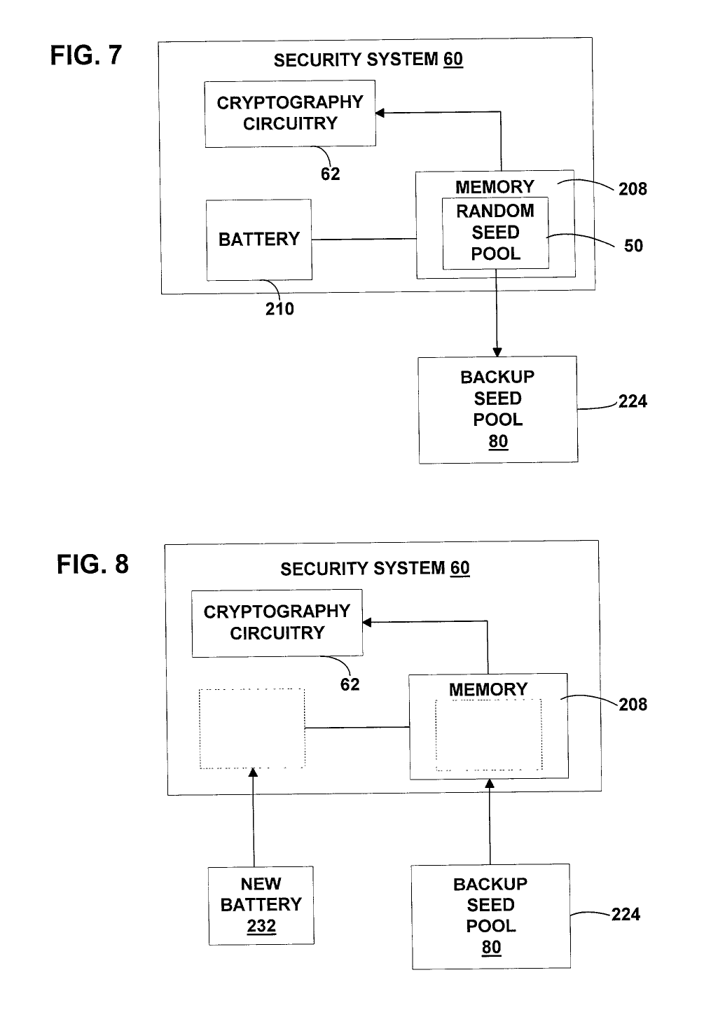

FIG. 6 is a flow chart illustrating an exemplary process 200 for maintaining a random seed pool in a security system, such as security system 60 of FIGS. 7-10. As illustrated, the process 200 comprises a seed pool generation process 201 (e.g., process 160 illustrated in FIG. 5B) and a seed pool backup process 203. The seed pool generation process 201 proceeds by generating a random seed pool (block 204), such as random seed pool 50 illustrated in both FIGS. 6 and 7. The random seed pool 50 may be disposed in a variety of electronic or computing devices, such as security system 60, which may be a server, a personal computer, a laptop computer, a personal digital assistant, or a variety of other processor-based devices.

In this exemplary embodiment, the security system 60 illustrated by FIGS. 7-10 comprises memory 208, a limited life battery 210, and cryptography circuitry 62. The memory 208 is provided for storing the random seed pool 50. The limited life battery 210 (e.g. 4-5 years life) is provided for powering the memory 208. If the limited life battery 210 fails, then the random seed pool 50 stored on the memory 208 is lost. The seed pool 50 also may be lost or corrupted due to various other factors.

As described above, the seed pool generation process 201 may ensure randomness of the random seed pool 50 by routinely modifying the random seed pool 50 using the seed pool randomizer 64 (block 214). For example, the seed pool randomizer 64 may add a variety of random bits to the random seed pool 50, such as random bits relating to the timer, the MAC address, or a variety of other resources (block 216). The process 201 then uses the random seed pool 50 to generate a random number for secure access and communications, as needed during operation of the security system 60 (block 218).

The seed pool backup process 203 ensures that the random seed pool 50 generated and modified by the seed pool generation process 201 is available to the security system 60 in the event of a data loss, such as a total power loss associated with a battery failure. Accordingly, the process 203 periodically backs-up the random seed pool 50 by transmitting the seed pool backup 80 to a storage device (block 220), such as storage device 224 illustrated by FIG. 7. The timing for these periodic backups of the seed pool 50 may be determined based on the maximum write capacity or write cycle (e.g., 100,000) for the system. The storage device 224 may embody any suitable physical memory, such as a CDRW media, a DVD media, a tape drive, or one or more hard disk drives. Moreover, the storage device 224 may be disposed locally at the security subsystem or at a remote system, such as the external device 22.

The seed pool backup process 203 also continually queries whether the random seed pool 50 is available or lost (block 226). For example, the process 203 may evaluate the presence or absence of the seed pool 50 before attempting to backup the seed pool 50. If the query 226 indicates that the random seed pool 50 has not been lost, then the process 203 continues executing the seed pool generation process 201 and the security system 60 is able to secure the host system. However, if the query 226 indicates that the random seed pool 50 has been lost or corrupted, then the process 203 proceeds to retrieve the seed pool backup 80 (block 228) and to restore the seed pool backup 80 to the memory 208 of the security system 60 (block 230). If the seed pool 50 has been lost due to a total power loss (e.g., a battery failure simultaneous with a primary power loss/shutdown), as illustrated by FIG. 8, then a new battery 232 may be installed into the security system 60 to power the memory 208 prior to restoring the seed pool backup 80. In an exemplary embodiment, the seed pool 50 is periodically written to a remote server (e.g., the external device 22), which may automatically restore the seed pool backup 80 to the memory 208 upon restoring power to the security system 60.

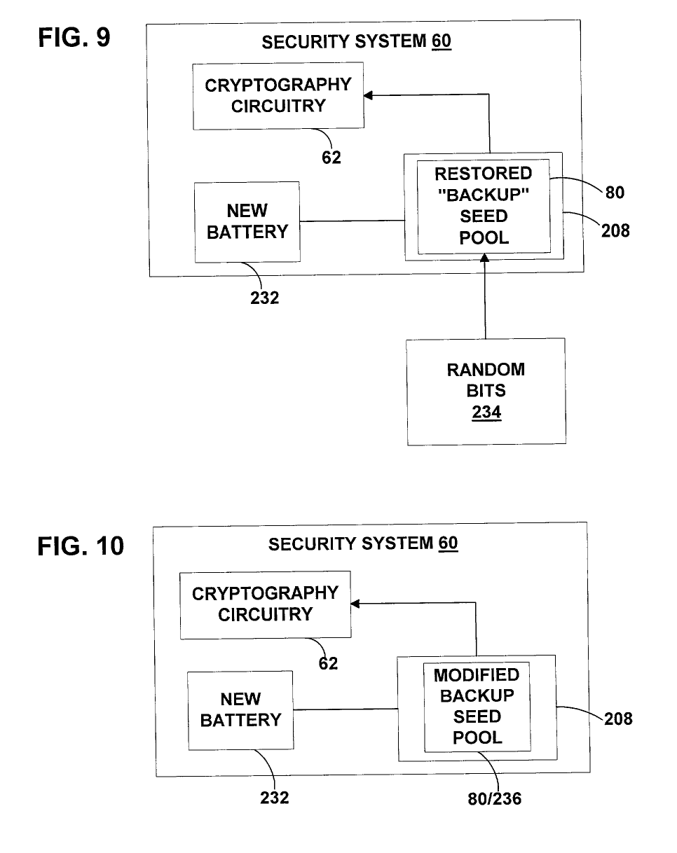

As illustrated by FIGS. 6 and 9, the process 201 then proceeds to modify the restored seed pool backup 80 (block 214) by adding random bits, such as random bits 234, to account for any loss of random bits between the time of the last backup and the total power and seed pool loss of the security system 60. For example, as discussed above, the present technique can mask in a variety of random bits corresponding to the system timer, the MAC address, and various other resources. As illustrated by FIG. 10, the result of the foregoing restoration and modification is a modified backup seed pool 236, which can be used by the security system 60 to generate a random number for the cryptography circuitry 62.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims. For example, any of the foregoing techniques for seed pool generation and seed pool backup and restoration can be used for any electronic or computing device in an on-site or remote application. If the seed pool is backed-up to a local storage device, then the system may automatically restore and add random bits to the restored backup seed pool upon re-powering the system. Similarly, if the seed pool is backed-up to a remote storage device, then the system may automatically request the backup seed pool from the remote storage device for restoration to the system.

What is claimed is:

1. A method of ensuring a random number for a cryptographic security subsystem of a processor-based device, the method comprising the acts of:
obtaining a seed pool comprising a plurality of bits for generating the random number;
remotely storing a seed pool backup of the seed pool via a network; and
restoring the seed pool backup to local memory following a power loss event causing loss to the seed pool.

2. The method of claim 1, wherein the act of remotely storing the seed pool comprises the act of periodically storing the seed pool backup on a remote storage device.

3. The method of claim 2, wherein the act of periodically storing the seed pool backup comprises the act of executing a backup event at a backup interval based on a write cycle characteristic of the remote storage device.

4. The method of claim 1, comprising the act of modifying the seed pool backup with additional random bits to ensure randomness for generating the random number.

5. The method of claim 4, wherein the act of modifying the seed pool backup with additional random bits comprises the act of capturing one or more bits of data from a free-running timer.

6. The method of claim 4, wherein the act of modifying the seed pool backup with additional random bits comprises the act of capturing one or more bits of data from a local hardware device.

7. The method claim 1, wherein the act of restoring the seed pool backup comprises the act of automatically retrieving the seed pool backup via the network upon restoring power to the cryptographic security subsystem.

8. The method of claim 7, wherein the act of automatically retrieving the seed pool backup comprises requesting the seed pool backup from a remote management system.

9. The method of claim 1, wherein the power loss event is a battery failure resulting in memory loss of the seed pool from the local memory.

10. The method of claim 1, wherein the act of restoring the seed pool backup comprises the act of transmitting the seed pool backup from remote storage to the local memory via the network following a battery replacement for the local memory.

11. A method of restoring a seed pool for generating a random number for a security system, the method comprising the acts of:
transmitting a periodically stored backup of the seed pool to the security system via a network following loss of the seed pool from the security system; and
repopulating local memory of the security system with the periodically stored backup for use in generating the random number.

12. The method of claim 11, comprising the act of modifying the periodically stored backup with additional random bits to ensure randomness.

13. The method of claim 12, wherein the act of modifying the periodically stored backup with additional random bits comprises the act of capturing one or more bits of data from one or more local hardware components.

14. The method of claim 11, comprising the act of periodically storing the seed pool in a remote storage device via the network at an interval based on a write cycle characteristic of the remote storage device to maintain availability of the seed pool as the periodically stored backup.

15. The method claim 11, wherein the act of transmitting the periodically stored backup comprises the act of transferring the periodically stored backup to the security system after restoring battery power to the security system.

16. The method of claim 15, wherein the act of transferring the periodically stored backup comprises automatically initiating a seed pool restoration event using the periodically stored backup stored on a remote server after restoring battery power by replacing a battery for the local memory of the security system.

17. A security system, comprising:
a security subsystem, comprising:
a power dependent memory device;
a limited life battery for the power dependent memory device;
a seed pool stored on the power dependent memory device, wherein the seed pool comprises a plurality of random bits; and
security logic configured to generate a cryptographic key to establish a secure communication session between the electronic device and an external device, wherein the security logic generates the cryptographic key from the seed pool; and
a security backup system, comprising:
a remote storage device;
a backup control module configured for periodically storing a backup of the seed pool in the remote storage device; and
a restoration control module configured for repopulating the power dependent memory device with the backup following replacement of the limited life battery.

18. The system of claim 17, comprising a remote security interface configured for interacting with the security subsystem and the security backup system.

19. The system of claim 17, wherein the security backup system comprises a seed pool modification module configured for capturing one or more bits of data from a hardware component and adding the one or more bits to the backup.

20. The system of claim 17, wherein the security backup system comprises an automation module configured for automatically initiating repopulation of the memory device with the backup.
